(19) United States
(12) Patent Application Publication
(10) Pub. No.: US 2025/0348448 A1
(43) Pub. Date: Nov. 13, 2025

(54) DERIVING SYSTEM CLOCK FROM GATED DATA CLOCK

(71) Applicant: Advanced Micro Devices, Inc., Santa Clara, CA (US)

(72) Inventor: David Da-Wei LIN, Westborough, MA (US)

(21) Appl. No.: 18/662,974

(22) Filed: May 13, 2024

(51) Int. Cl. G06F 13/16; G06F 1/08

(52) U.S. Cl. CPC G06F 13/1689; G06F 1/08

(57) ABSTRACT

A memory system comprises a memory controller coupled to a memory device. The memory controller is configured to generate and transmit a data clock signal to the memory device. The memory controller does not transmit a system clock signal to the memory device. The memory device is configured to receive the data clock signal and internally generate a system clock signal based on the data clock signal according to a ratio. The data clock signal from the memory controller is a gated data clock signal that is transmitted to the memory device based on a demand from command or data traffic between the memory controller and the memory device.

### TECHNICAL FIELD

Examples of the present disclosure generally relate to memory system power optimization, and in particular to deriving a system clock from a gated data clock for reducing power consumption in a memory system.

### BACKGROUND

Dynamic random-access memory (DRAM) is a type of memory that is widely used in computing systems due to its ability to offer fast access times, high storage capacity, and relatively low cost. Most modern DRAM chips adhere to various double data rate (DDR) standards established by the Joint Electron Devices Engineering Council (JEDEC) Solid State Technology Association.

Recently, for the Low Power Double Data Rate (LPDDR) design, an increase in the number of data pins on a DRAM chip is proposed to address the demand for higher data bandwidth. While increasing the number of data pins can offer higher data bandwidth, it may also come at the cost of increased circuit size and power consumption.

Thus, solutions for allowing higher data bandwidth while maintaining a compact circuit size and minimizing power consumption in memory systems are desired.

### SUMMARY

Systems, methods, and devices are described for deriving a system clock (CK) from a gated data clock (WCK) in a memory system.

According to one aspect, a system includes a memory controller configured to generate a data clock signal, and a memory device coupled to the memory controller. The memory device is configured to receive the data clock signal from the memory controller, and generate a system clock signal based on the data clock signal.

According to another aspect, a method includes providing, by a memory controller, a data clock signal to the memory device, and generating, by a memory device, a system clock signal based on the data clock signal.

According to yet another aspect, a memory device includes data clock reception circuitry configured to receive a data clock signal, and internal clock generation circuitry configured to generate a system clock signal based on the data clock signal.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1A illustrates a block diagram of a system, in accordance of an example embodiment of the present disclosure.

FIG. 1B illustrates a block diagram of a memory system of the system in FIG. 1A, in accordance of an example embodiment of the present disclosure.

FIG. 2A illustrates a flowchart of a method for performing a read operation by a memory system, in accordance of an example embodiment of the present disclosure.

FIG. 2B illustrates a flowchart of a method for performing a write operation by a memory system, in accordance of an example embodiment of the present disclosure.

FIGS. 3A-i, 3A-ii, and 3A-iii illustrate a timing diagram of various signals during a read operation performed by a memory system, in accordance of an example embodiment of the present disclosure.

FIGS. 3B-i, 3B-ii, and 3B-iii illustrate a timing diagram of various signals during a write operation performed by a memory system, in accordance of an example embodiment of the present disclosure.

FIGS. 4A-i, 4A-ii, and 4A-iii illustrate a timing diagram of various signals during a read operation performed by a memory system, in accordance of an example embodiment of the present disclosure.

FIGS. 4B-i, 4B-ii, and 4B-iii illustrate a timing diagram of various signals during a write operation performed by a memory system, in accordance of an example embodiment of the present disclosure.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments of the present disclosure implement various methods for reducing the number of command and clock signal input/output (I/O) pins at the interface between a memory controller and a memory device, and reusing the circuit area to support a higher number of data pins to achieve a higher data transmission bandwidth.

According to an example method, a system clock signal (CK) is not transmitted from the memory controller to the memory device. Instead, the memory device internally generates (or derives) the CK based on a gated data clock signal (WCK) received from the memory controller. For example, the CK can be generated by the memory device based on a predefined WCK to CK ratio. Because the CK is internally generated by the memory device, instead of being transmitted from the memory controller, the I/O pins that would otherwise be designated for transmitting or receiving the CK can be used for data (or other signal) transmission or reception.

According to another example method, during an access operation (e.g., a read or write operation), while the memory controller generates an active WCK internally, the memory controller does not transmit the WCK to the memory device continuously. The memory controller includes WCK gating circuitry and transmits a gated version of the WCK to the memory device based on a demand from command or data traffic between the memory controller and the memory device.

According to another example method, a revised command bus encoding is employed to support more complex multi-cycle commands such that the number of command pins can be reduced to allow for a higher number of I/O pins for data (or other signal) transmission or reception.

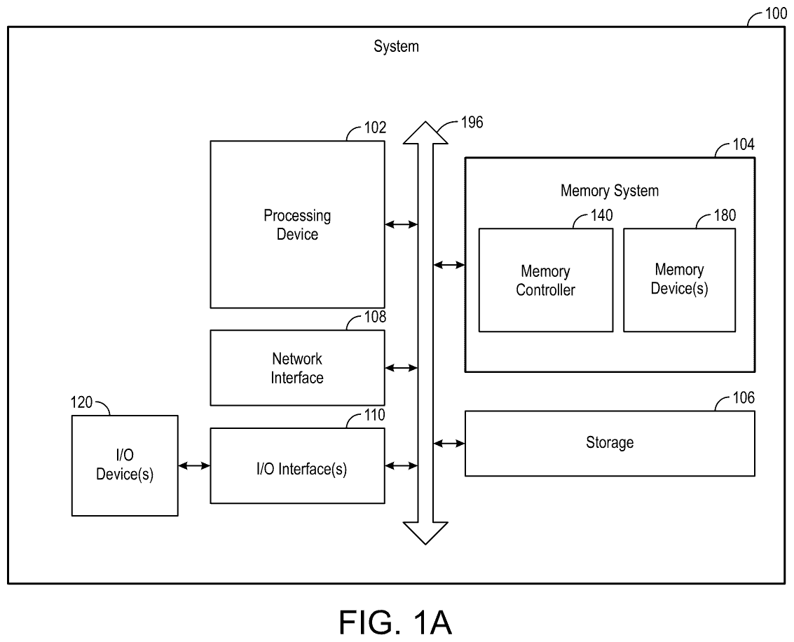

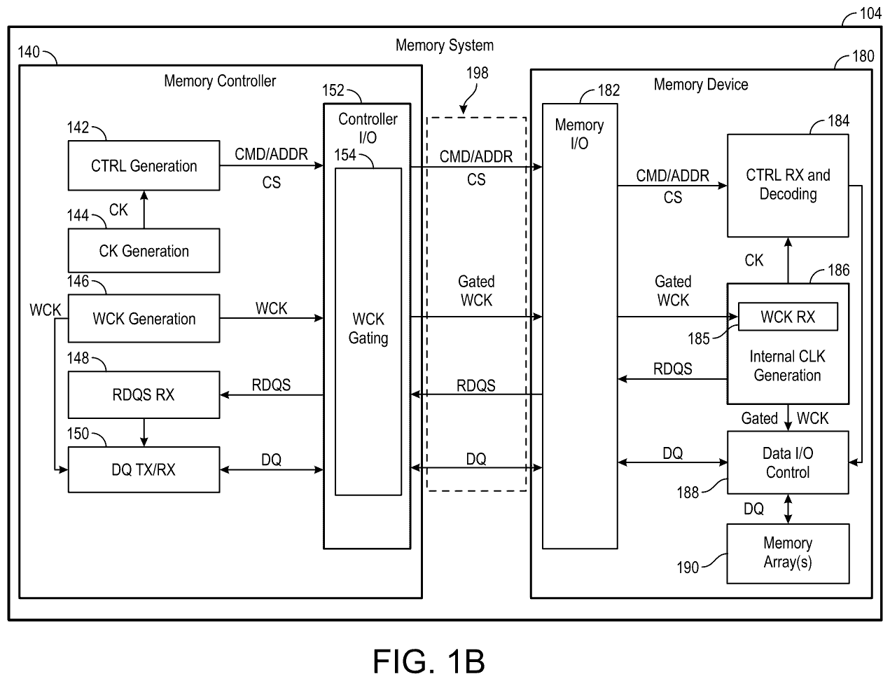

FIG. 1A illustrates a block diagram of a system 100, in accordance with an example embodiment of the present disclosure. The system 100 includes a processing device 102, a memory system 104, a storage 106, a network interface 108, input/output (I/O) interfaces 110, and I/O devices 120. As shown in FIG. 1A, one or more components of the system 100 are connected together via a bus 196. The bus 196 may include one or more types of interconnects, links, fabric units, buses, and other connectivity modules.

The processing device 102 may execute various software instructions (e.g., an operating system, programs, applications, drivers, etc.) and exchange control and data signals with the memory system 104 and/or the I/O devices 120. For example, the processing device 102 may execute software instructions to perform memory operations. The processing device 102 may be a single-or multi-core processor. In some embodiments, the processing device 102 may be a combination of one or more central processing unit (CPU) cores, one or more graphics processing unit (GPU) cores, one or more image signal processing unit (ISP) cores, and one or more digital signal processing unit (DSP) cores, on a single semiconductor die/chip. In some embodiments, the processing device 102 may include a series of pipe-lined processors and/or multiple parallel processors. In some embodiments, the processing device 102 may include any other suitable types of processor.

The memory system 104 includes a memory controller 140 and a memory device 180 communicatively coupled to the memory controller 140 through one or more links or buses. The memory controller 140 may be any type of memory controller accessible by the processing device 102. In some embodiments, the processing device 102 and the memory controller 140 may be collectively referred to as a host (or a host device) that is communicatively coupled to the memory device 180. It should be noted that although a single memory controller 140 and a single memory device 180 are shown in FIG. 1A, the memory system 104 may include multiple memory controllers 140 and multiple memory devices 180.

The memory device 180 includes one or more volatile or non-volatile resources. In some embodiments, the memory resources in the memory device 180 may include, without limitation, high-bandwidth memory (HBM), non-volatile memory (NVM), Dynamic Random Access Memory (DRAM), Static Random Access Memory (SRAM), NAND flash memory, NOR flash memory, Ferroelectric Random Access Memory (FeRAM) and other suitable types of memory. For example, the memory device 180 may include one or more DRAM, synchronous DRAM (SDRAM), first, second, third, fourth, or fifth, among other, generation double data rate (DDR) memory (e.g., DDR SDRAM), and LPDDR memory (e.g., LPDDR SDRAM).

The memory controller 140 may transmit data to and receive data from the memory device 180 based on instructions from the processing device 102. The memory controller 140 may also provide various signals to facilitate communication between the processing device 102 and the memory device 180 for performing memory operations. For example, the memory controller 140 may provide timing commands for controlling the timing of various operations. The memory controller 140 may provide mode register write and read commands for performing mode register write and read operations. The memory controller 140 may also provide access commands (e.g., command and address signals (CA)) for accessing the memory device 180, such as read and write commands for performing read and write operations, respectively. The command signals provided by the memory controller 140 to the memory device 180 may further include chip select signals (CS). The chip select signals can be provided to different memory devices, where one or more selected memory devices (or chips) will respond to the commands and perform operations based on the commands. For example, although all of the memory devices can be provided with commands, addresses, data, and clock signals, active chip select signals provided on respective select signal lines are used to select which of the memory devices will perform the corresponding operations in response to the command signals.

The storage 106 includes a fixed or removable storage, for example, a hard disk drive, a solid state drive, an optical disk, or a flash drive.

The network interface 108 is used to receive and send network messages across a network (not explicitly shown in FIG. 1A). The I/O interfaces 110 may include, without limitation, one or more peripheral component interconnect (PCI) bus, PCI-Extended (PCI-X), PCIE (PCI Express) bus, gigabit Ethernet (GBE) bus, and universal serial bus (USB)).

The I/O devices 120 includes various input and output devices. For example, the input devices may include, without limitation, a keyboard, a keypad, a touch screen, a touch pad, a detector, a microphone, an accelerometer, a gyroscope, a biometric scanner, or a network connection device (e.g., a wireless local area network card for transmission and/or reception of wireless signals). The input devices may communicate with the processing device 102 through input drivers which allow the processing device 102 to receive input from the input devices. The output devices may include, without limitation, a display, a speaker, a printer, a haptic feedback device, one or more lights, an antenna, or a network connection device (e.g., a wireless local area network card for transmission and/or reception of wireless signals). The output devices may communicate with the processing device 102 through output drivers which allow the processing device 102 to send output to the output devices.

It should be appreciated that the system 100 can include other components not shown in FIG. 1A, and can be configurable in a variety of ways. In various implementations, the system 100 may be any suitable device such as, without limitation, a computing device, a server (e.g., a cloud server), a mobile device (e.g., a mobile phone, a tablet, a laptop, or a wearable), a desktop computer, a gaming console, a set-top box, a printer, a camera, or any other suitable device. The system 100 may be configured as any one or more of the suitable devices above and/or a variety of other devices without departing from the spirit or scope of the present disclosure.

FIG. 1B illustrates a block diagram of the memory system 104 shown in FIG. 1A, in accordance with an example embodiment of the present disclosure. As shown in FIG. 1B, the memory system 104 includes the memory controller 140 coupled to the memory device 180 through one or more links (or buses) 198.

The memory controller 140 includes control signal (CTRL) generation circuitry 142, system clock signal (CK) generation circuitry 144, data clock signal (WCK) generation circuitry 146, read data strobe signal (RDQS) reception circuitry 148, data signal (DQ) transmit/receive (TX/RX) circuitry 150, and controller I/O circuitry 152. The memory controller 140 may also include other circuit components, such as buffers and registers, not explicitly shown in FIG. 1B.

The CTRL generation circuitry 142 may generate control signals including, without limitation, command signals (CMD), address signals (ADDR), and chip select signals (CS). In some embodiments, the CMD and ADDR may be collectively referred to as a command and address signal (CA). The CK generation circuitry 144 may generate a system clock signal (CK). The CK may be used as a clock source for transmitting the control signals such as the command and address signals.

The WCK generation circuitry 146 may generate a WCK and provide the WCK the controller I/O circuitry 152. The WCK, when transmitted to the memory device 180, can be used to capture data received from the memory controller 140. The WCK may also be used to generate a read data strobe signal (RDQS). In some embodiments, instead of the CK, the WCK may be used as a clock source for transmitting the control signals such as the command and address signals.

The RDQS reception circuitry 148 may receive the RDQS from the memory device 180. For example, during a read operation, the RDQS reception circuitry 148 may receive the RDQS along with read data from the memory device 180, where the edges of the RDQS are used by the memory controller 140 to capture the read data.

The DQ TX/RX circuitry 150 may transmit data to and receive data from the memory device 180. The DQ TX/RX circuitry 150 may also transmit data to and receive data from the processing device 102 shown in FIG. 1A.

The controller I/O circuitry 152 may drive and receive signals on the links (or buses) 198. The controller I/O circuitry 152 may be known as a physical layer (PHY) and be configured to control electrical characteristics (e.g., voltage levels, phase, delays, frequencies, etc.) or to receive signals based on the electrical characteristics of signaling on the links (or buses) 198.

The controller I/O circuitry 152 may include WCK gating circuitry 154 for gating the WCK and providing a gated version of the WCK to the memory device 180 on demand, for example, in anticipation of or in response to command or data traffic between the memory controller 140 and the memory device 180. For example, when a command signal or a data signal (or a data strobe signal) starts (or is about to start) toggling, the WCK gating circuitry 154 transmits the gated WCK to the memory device 180. The gated WCK enables the memory device 180 to generate a CK based on the gated WCK to capture command signals. The gated WCK also enables the memory device 180 to capture (or clock) data and generate RDQSs.

The controller I/O circuitry 152 may also include one or more buffers (not explicitly shown in FIG. 1B), such as read and write buffers, to support communication between the memory controller 140 and the memory device 180. In an example, the buffers may receive and/or store data obtained from the memory device 180 during a read operation and output the data to the DQ TX/RX circuitry 150. In another example, the buffers may receive and/or store data from the DQ TX/RX circuitry 150 and output the data to the memory device 180 during a write operation.

As shown in FIG. 1B, the memory device 180 may include memory I/O circuitry 182, CTRL reception and decoding circuitry 184, internal clock generation circuitry 186, data I/O control circuitry 188, and memory array(s) 190. The memory device 180 may also include other circuit components, such as buffers and registers, not explicitly shown in FIG. 1B.

The memory I/O circuitry 182 may drive and receive signals on the links (or buses) 198. The memory I/O circuitry 182 may be known as a PHY layer and be configured to control electrical characteristics (e.g., voltage levels, phase, delays, frequencies, etc.) or to receive signals based on the electrical characteristics of signaling on the links (or buses) 198. For example, memory I/O circuitry 182 may include buffers to capture write data from and output read data to the memory controller 140 via the links (or buses) 198.

The CTRL reception and decoding circuitry 184 may receive control signals (e.g., the CMD, ADDR, CS, and etc.) from the memory controller 140 through the memory I/O circuitry 182. The CTRL reception and decoding circuitry 184 may also decode various commands (e.g., read and write commands) provided by the memory controller 140.

The internal clock generation circuitry 186 may include WCK reception circuitry 185 for receiving the gated WCK. The internal clock generation circuitry 186 may internally generate a system clock signal (CK) based on the gated WCK from the memory controller 140. The internally generated CK may be used for clocking the received control signals (e.g., the CMD, ADDR, CS, and etc.) from the memory controller 140. The internal clock generation circuitry 186 may also generate an RDQS based on the gated WCK. For example, the RDQS is a clock signal for the data lines, in which each data byte may be associated with a corresponding data strobe. The memory device 180 may provide data and the associated RDQS to the memory controller 140 for receiving data from the memory device 180 during read operations.

The data I/O control circuitry 188 may input data (e.g., write data) to the memory array(s) 190 during write operations, and output data (e.g., read data) from the memory array(s) 190 during read operations.

The memory array(s) 190 may include multiple memory cells (e.g., DRAM memory cells) that can store data. The memory array(s) 190 may be arranged into multiple memory banks. The memory array(s) 190 may be accessed (e.g., read or written) according to access (e.g., read or a write) commands.

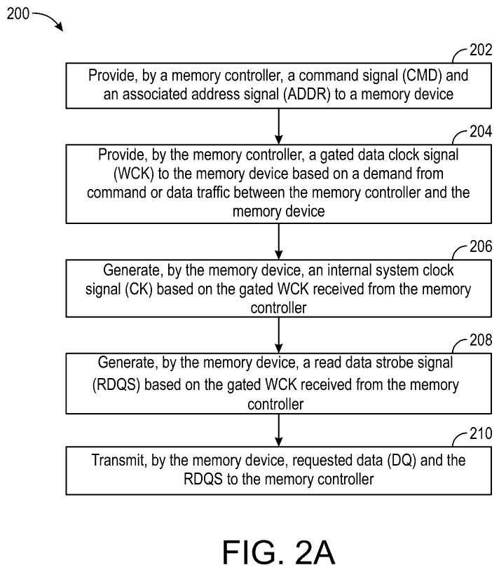

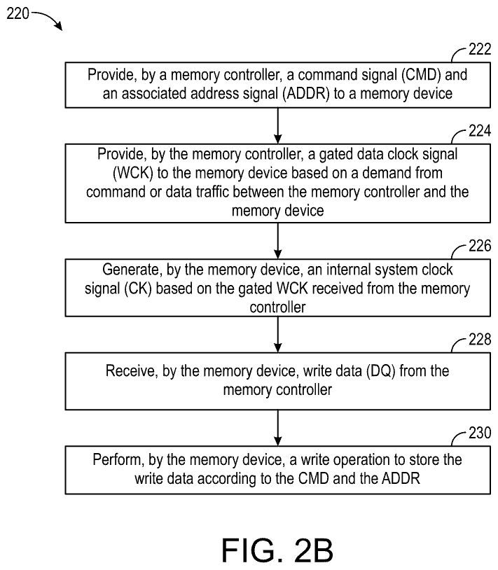

FIG. 2A illustrates a flowchart of a method 200 for performing a read operation by a memory system having a memory controller and a memory device, in accordance of an example embodiment of the present disclosure. In one embodiment, the memory system may substantially correspond to the memory system 104 shown in FIG. 1B.

At block 202, the memory controller (e.g., the memory controller 140 in FIG. 1B) provides a command signal (CMD) and an associated address signal (ADDR) to the memory device (e.g., the memory device 180 in FIG. 1B). For a read operation, the CMD may include a read command, and the ADDR may include an address or location associated with the requested data. The memory controller may also provide a chip select signal (CS) to the memory device, where the CMD and ADDR may be timed to coincide with the CS.

At block 204, the memory controller provides a gated data clock signal (WCK) to the memory device based on a demand from command or data traffic between the memory controller and the memory device. For example, the memory controller may start to transmit the gated WCK at its WCK pin(s) when the memory controller starts (or is about to start) to transmit a command signal at its CMD pin(s). The memory controller may also start to transmit the gated WCK at its WCK pin(s) when the memory device starts (or is about to start) to transmit read data or a read data strobe signal to the memory controller. The memory controller may also start to transmit the gated WCK at its WCK pin(s) when the memory controller starts (or is about to start) to transmit write data to the memory device.

At block 206, the memory device generates an internal system clock signal (CK) based on the gated WCK received from the memory controller. The internally generated CK is used by the memory device for timing the provision and receipt of the CMD and ADDR from the memory controller. For example, with reference to FIG. 1B, the internal clock generation circuitry 186 of the memory device 180 may generate an internal CK based on a predetermined (or predefined) ratio of CK to WCK, for example, by using a frequency divider. For example, the CK and the WCK may have a ratio of 1:2 or 1:4. In another example, the CK and the WCK may have a ratio of 1:1. In other examples, the CK and the WCK may have any suitable ratio for operation in the memory system.

At block 208, the memory device generates a read data strobe signal (RDQS) based on the gated WCK received from the memory controller. For example, with reference to FIG. 1B, the internal clock generation circuitry 186 may generate an RDQS based on the gated WCK received from the memory controller 140.

At block 210, the memory device transmits the requested data (DQ) based on the read command to the memory controller. In the read operation, the RDQS is also transmitted along with the requested data (DQ) for the memory controller to capture the requested data.

FIG. 2B illustrates a flowchart of a method 220 for performing a write operation by a memory system having a memory controller and a memory device, in accordance of an example embodiment of the present disclosure. In one embodiment, the memory system may substantially correspond to the memory system 104 shown in FIG. 1B.

At block 222, the memory controller (e.g., the memory controller 140 in FIG. 1B) provides a CMD and an associated ADDR to the memory device (e.g., the memory device 180 in FIG. 1B). For a write operation, the CMD may include a write command, and the ADDR may include an address or location associated with the write data. The memory controller may also provide a CS to the memory device, where the CMD and ADDR may be timed to coincide with the CS.

At block 224, the memory controller provides a gated WCK to the memory device based on a demand from command or data traffic between the memory controller and the memory device. For example, the memory controller may start to transmit the gated WCK at its WCK pin(s) when the memory controller starts (or is about to start) to transmit a command signal at its CMD pin(s). The memory controller may also start to transmit the gated WCK at its WCK pin(s) when the memory controller starts (or is about to start) to transmit write data to the memory device.

At block 226, the memory device generates an internal CK based on the gated WCK received from the memory controller. The internally generated CK is used by the memory device for timing the provision and receipt of the CMD and ADDR received from the memory controller. For example, with reference to FIG. 1B, the internal clock generation circuitry 186 of the memory device 180 may generate an internal CK based on a predetermined (or predefined) ratio of CK to WCK, for example, by using a frequency divider. For example, the CK and the WCK may have a ratio of 1:2 or 1:4. In another example, the CK and the WCK may have a ratio of 1:1. In other examples, the CK and the WCK may have any suitable ratio for operation in the memory system.

At block 228, the memory device receives write data (DQ) from the memory controller. The gated WCK may be used to capture (or clock) the write data.

At block 230, the memory device performs a write operation to store the write data according to the CMD and the ADDR.

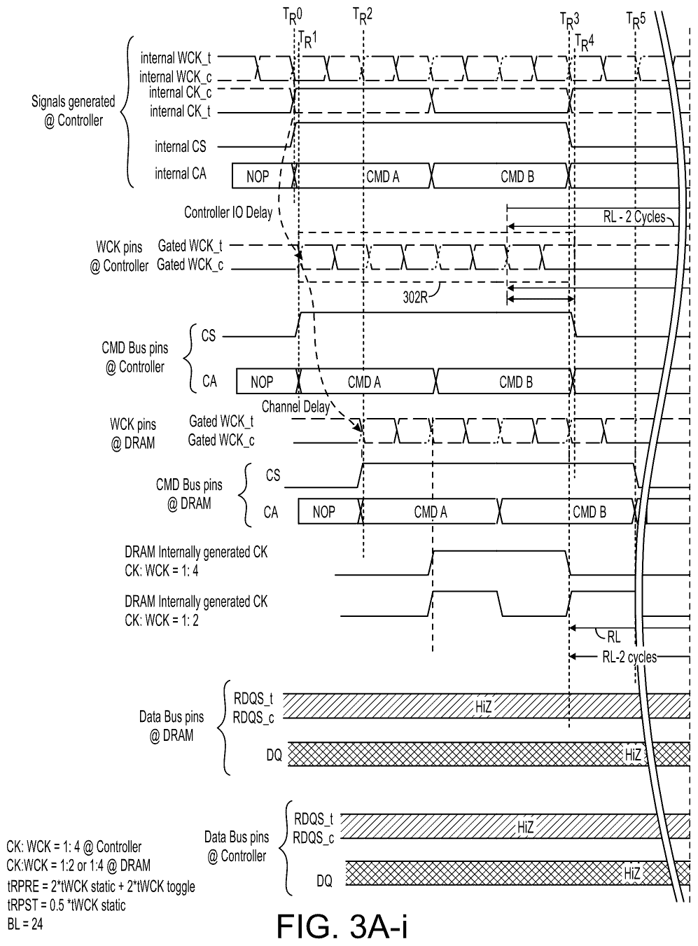

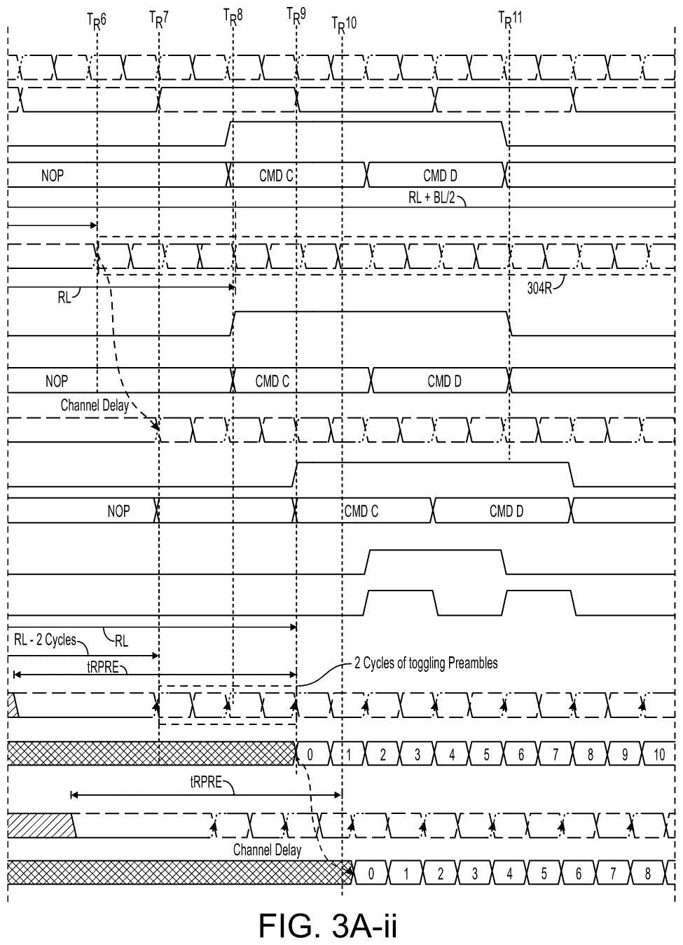

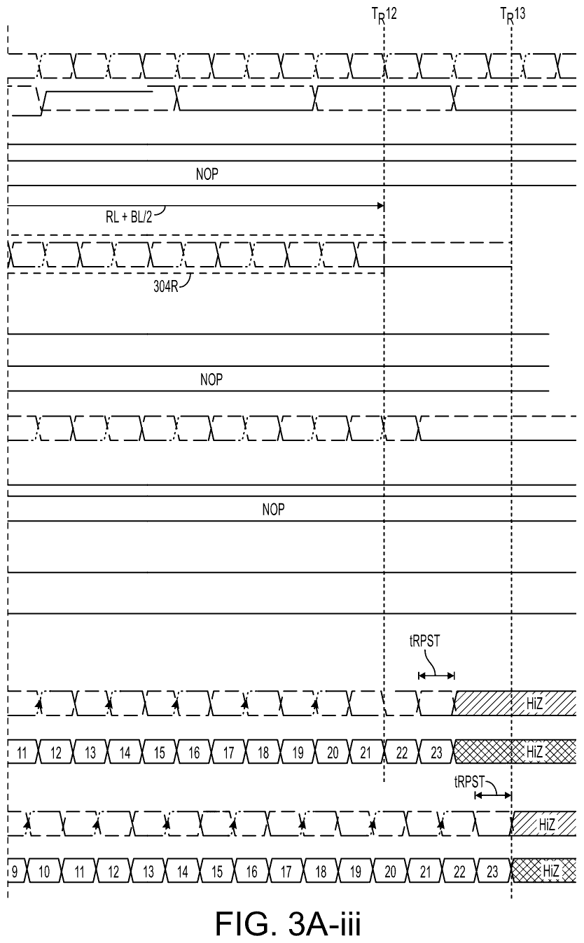

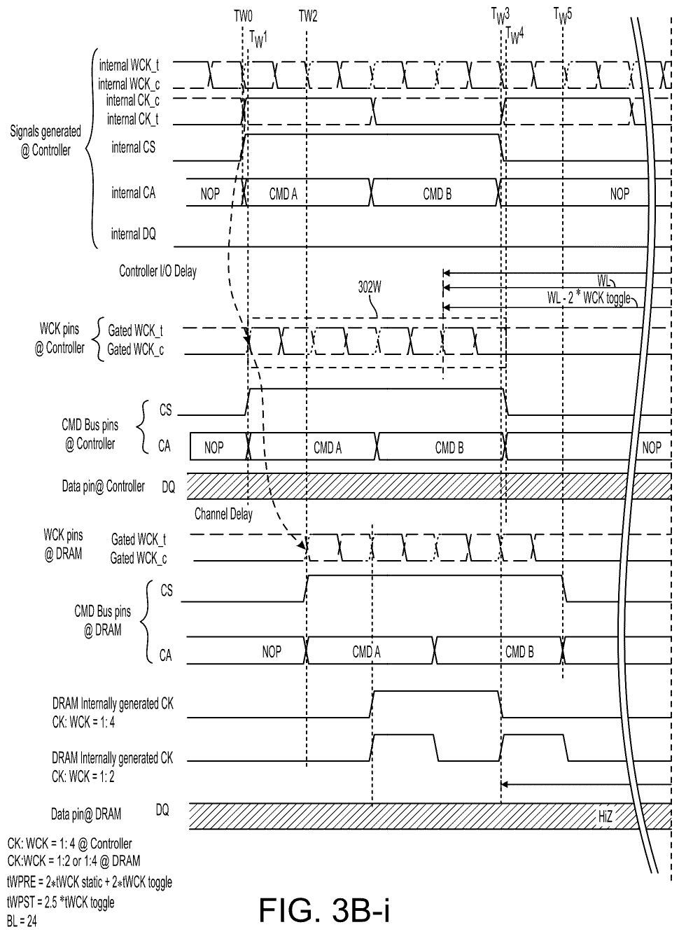

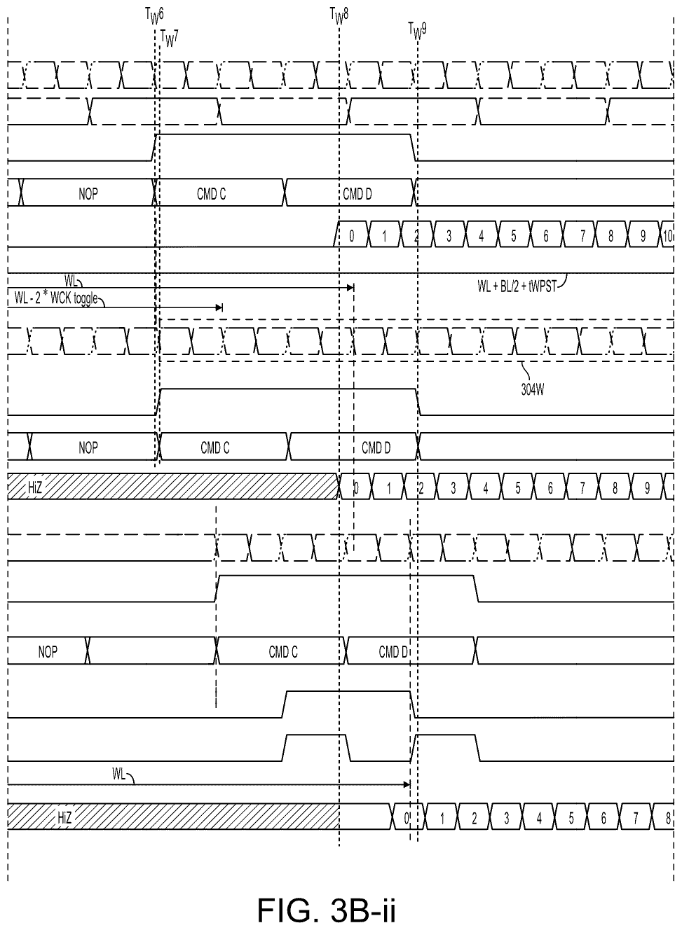

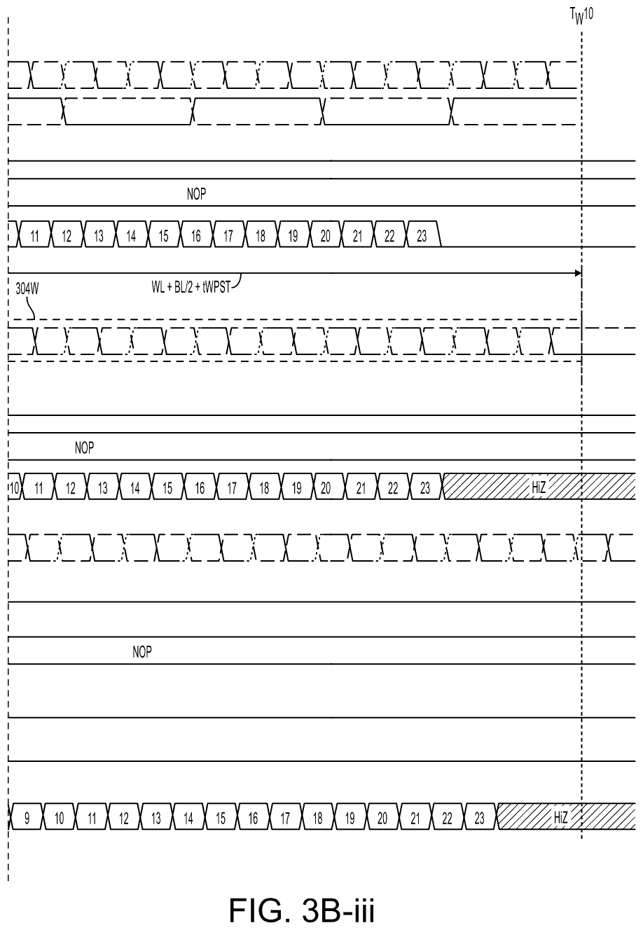

FIGS. 3A-i, 3A-ii, and 3A-iii (collectively referred to as FIG. 3A) illustrate a timing diagram of various signals during a read operation performed by a memory system, in accordance of an example embodiment of the present disclosure. In one embodiment, the memory system may substantially correspond to the memory system 104 shown in FIGS. 1A and 1B. The memory system may include a memory controller and a memory device, which may substantially correspond to the memory controller 140 and the memory device 180, respectively, shown in FIG. 1B.

As shown in FIG. 3A, the memory controller generates a WCK and a CK continuously, where the WCK and the CK stay active internally. For example, a clock signal (e.g., the CK or WCK) is active when the clock signal transitions between low and high clock levels periodically. Conversely, a clock signal (e.g., the CK or WCK) is inactive when the clock signal maintains a constant clock level and does not transition periodically.

In the present embodiment, the WCK includes a pair of complementary signals, WCK_t and WCK_c. For example, a rising edge of the WCK_t occurs at the same (or substantially the same) time as a falling edge of the WCK_c. Also, a rising edge of the WCK_c occurs at the same (or substantially the same) time as a falling edge of the WCK_t. Also, the CK includes a pair of complementary signals, CK_t and CK_c. For example, a rising edge of the CK_t occurs at the same (or substantially the same) time as a falling edge of the CK_c. Also, a rising edge of the CK_c occurs at the same (or substantially the same) time as a falling edge of the CK_t.

As shown in FIG. 3A, the WCK may have a higher clock frequency than the CK. For example, the WCK may have a clock frequency that is four times of the clock frequency of the CK. In another example, the WCK may have a clock frequency that is two times of the clock frequency of the CK. In other examples, the CK and the WCK may have any other suitable ratio.

As shown in FIG. 3A, the memory controller also generates a CS and a CA (e.g., including a read command and an associated address) internally. For example, the CS is generated by the memory controller to select a memory device to receive the CA to perform the read operation from a memory location corresponding to the address provided. In FIG. 3A, two command signals (e.g., a first command signal having a CMD A and a CMD B, and a second command signal having a CMD C and a CMD D) are shown, each being a two-cycle command that coincides with the timing of a corresponding CS.

As shown in FIG. 3A, after a controller I/O delay, a gated WCK, the CS, and the CA are provided to the controller I/O pins for transmission to the memory device through one or more links (or buses). For example, the WCK generated internally by the memory controller is provided to the controller I/O circuitry (e.g., the WCK gating circuitry 154 in FIG. 1B), which outputs the gated WCK to the WCK pin(s) of the memory controller. The CS and CA are provided to the CMD pin(s) of the memory controller.

According to embodiments of the present disclosure, the memory controller does not transmit the WCK to the memory device continuously. As shown in FIG. 3A, while the memory controller internally generates (or toggles) the WCK continuously, the WCK is gated by the controller I/O circuitry, and is not continuously provided to the controller I/O pins for transmission to the memory device. As described above, the memory controller may include the WCK gating circuitry configured to transmit the gated WCK to the memory device based on a demand from command or data traffic between the memory controller and the memory device. Among other advantages, gating the WCK and intermittently issuing the gated WCK on demand to the memory device can reduce power consumption of the memory system during access operations.

As shown in FIG. 3A, after a channel delay, the memory device receives the gated WCK, the CS, and the CA from the memory controller at the memory device I/O pins.

According to embodiments of the present disclosure, while the memory controller generates CK internally (e.g., for clocking the CA), the memory controller does not transmit the CK to the memory device. Instead, the memory device generates its CK internally based on the gated WCK received from the memory controller. For example, the memory device may generate its internal CK based on a predetermined (or predefined) CK to WCK ratio (e.g., 1:2, 1:4, etc.).

As shown in FIG. 3A, the CK and WCK internally generated by the memory controller 140 may have a ratio of (e.g., 1:2). In one embodiment, the memory device 180 may generate the CK internally using the WCK received from the memory controller 140 based on the same ratio (e.g., 1:2) in the memory controller. As such, the CK generated by the memory device 180 may have the same or substantially the same characteristics (e.g., frequency and duration) as the CK generated by the memory controller 140.

In another embodiment, the memory device 180 may generate the CK internally using the WCK received from the memory controller 140 based on a ratio (e.g., 1:4) that is different from the ratio (e.g., 1:2) in the memory controller.

Among other advantages, not transmitting the CK from the memory controller to the memory device can reduce power consumption of the memory system. In addition, because the CK on the memory device is generated based on the gated WCK received from the memory controller, the CK is not continuously generated by the memory device, thereby further reducing power consumption of the memory system. Also, because the CK is internally generated by the memory device based on the gated WCK received from the memory controller, synchronization of the CK and the WCK may not be necessary. Furthermore, not transmitting the CK from the memory controller to the memory device can allow the I/O pins that would otherwise be used for CK transmission to be used for transmission of other signals such as data or other control signals.

For the read operation, the memory device may also generate an RDQS based on the gated WCK. The memory device may retrieve the read data based on the read command and the associated address, and transmit the read data and the RDQS back to the memory controller. In one embodiment, the read data may be provided by the memory device to the memory controller in accordance with a timing relative to the receipt of the read command. For example, the timing may be based on a read latency value (RL) indicating when the read data needs to be transmitted by the memory device to the memory controller. The value of RL may be represented by a number of clock cycles of the WCK, and programmed by the memory controller in a mode register of the memory device. Thereafter, the memory controller receives the read data and the RDQS from the memory device at the memory controller I/O pins after a channel delay.

In FIG. 3A, two WCK toggling sessions are shown, where a first WCK toggling session 302_{R} starts at time T_{R}1 and ends at time T_{R}4, and a second WCK toggling session 304_{R} starts at time T_{R}6 and ends at time T_{R}12. During each of the first and second WCK toggling sessions, the gated WCK is active at the WCK pins of the memory controller.

For the first WCK toggling session 302_{R}, at the WCK pin(s) of the memory controller, the gated WCK starts toggling at time T_{R}1, in response to the CS and the first command signal (e.g., having CMD A and CMD B) being issued at the CMD bus pins of the memory controller. It is noted that, in the memory controller, the internal CS and internal CA (e.g., CMD A and COM B) are generated between time T_{R}0 and time T_{R}3. Because the memory controller transmits the CS and CA to the memory device at time T_{R}1, there is a need for transmitting the gated WCK at the same (or substantially the same) time. Before time T_{R}1, the internal WCK is gated by the controller I/O circuitry (e.g., by the WCK gating circuitry 154 in FIG. 1B). At time T_{R}4, the transmission of the CS and the first command signal ends at the CMD bus pins. As a result, the controller I/O circuitry stops the transmission of the gated WCK at the WCK pin(s) of the memory controller. In this example, during the first WCK toggling session 302_{R}, the gated WCK toggling has the same duration as the pulse width of the first command signal (e.g., having CMD A and CMD B), which also coincides with the CS. It is noted that, for the first WCK toggling session 302_{R}, the gated WCK is received at the WCK pins of the memory device between time T_{R}2 and time T_{R}5.

As shown in FIG. 3A, the second WCK toggling session 304_{R} starts at time T_{R}6 and ends at time T_{R}12. For example, the WCK starts toggling at the memory controller WCK pin(s) in anticipation of data traffic (e.g., an RDQS) from the memory device.

For the read operation, after receiving the read command, the memory device needs to locate and retrieve requested data and transmit the read data (DQ) back to the memory controller at the memory device I/O pins. The memory device also needs to generate and transmit the RDQS back to the memory controller along with the read data (DQ), where the RDQS (e.g., the edges of the RDQS) is used to capture data at the memory controller side.

According to the present embodiment, the memory device is in agreement with the memory controller (e.g., according to the LPDDR protocol) to transmit the requested data to the memory controller in accordance with a timing relative to the issuance of the CA by the memory controller. As shown in FIG. 3A, the memory device needs to start transmitting the read data at its data bus pin(s) back to the memory controller at time T_{R}9, which is an RL after the transmission of the read command at time T_{R}3.

Because the memory controller has information of commands it issues and the associated RL required from memory device, the memory controller can transmit the gated WCK in the right moment to provide referencing clocking for preamble edges along with strobe edges for RDQS generation. In some embodiments, the RDQS may start toggling before the DQ is transmitted from the memory device to the memory controller. The earlier timing of the memory device providing the RDQS to the memory controller allows a greater time period for the memory controller to address Inter-Symbol Interference (ISI). For example, as shown in FIG. 3A, to substantially eliminate ISI, 2 cycles of static preambles and 2 cycles of toggling preambles are toggled before valid RDQS and DQ are issued at time T_{R}9.

Because the RL is known, the WCK needs to start toggling at the WCK pin(s) of the memory device at time T_{R}7, which is RL—2 cycles after the associated read command (e.g., the internal CA at the memory controller) is transmitted at time T_{R}3. In addition, because the channel delay is known, the gated WCK at the WCK pin(s) of the memory controller needs to start toggling at time T_{R}6 to ensure that, after the known channel delay, the gated WCK at the WCK pin(s) of the memory device can start toggling at time T_{R}7.

As shown in FIG. 3A, the second WCK toggling session 304_{R} ends at time T_{R}12. In the embodiment shown, the burst length (BL) is 24, or a DQ stream of 24 bits is sent back from the memory device. As such, there are 12 (e.g., 24÷2) cycles of the RDQS needed along with the DQ. Thus, the memory controller stops toggling the gated WCK at its WCK pin(s) at time T_{R}12, which is 14 cycles (2 cycles of toggling preamble+12 cycles RDQS strobe for the associated DQ) after time T_{R}6.

It is noted that, during the second WCK toggling session 304_{R}, a second command signal (e.g., having CMD C and CMD D) is issued between time T_{R}8 and time T_{R}11 at the CMD bus pins of the memory controller. During this time, the second WCK toggling session 304_{R} has started due to the demand from the data traffic on the memory device side. Also, while the transmission of the second command signal (e.g., CMD C and CMD D) at the CMD bus pins ends at time T_{R}11, the second WCK toggling session 304_{R} ends at time T_{R}12 when the demand from the data traffic ends.

For the read operation, the memory controller receives the read data (DQ) from the memory device through the memory controller data pins at time T_{R}10. The data transmission ends at time T_{R}13, which is 12 cycles after time T_{R}10.

FIGS. 3B-i, 3B-ii, and 3B-iii illustrate (collectively referred to as FIG. 3B) a timing diagram of various signals during a write operation performed by a memory system, in accordance of an example embodiment of the present disclosure. In one embodiment, the memory system may substantially correspond to the memory system 104 shown in FIGS. 1A and 1B. The memory system may include a memory controller and a memory device, which may substantially correspond to the memory controller 140 and the memory device 180, respectively, shown in FIG. 1B.

Similar to the read operation described with reference to FIG. 3A, for the write operation, the WCK and CK are generated continuously and stay active internally in the memory controller.

As shown in FIG. 3B, the memory controller also generates a CS and a CA (e.g., including a write command and an associated address) internally. For example, the CS is generated by the memory controller to select a memory device to receive the CA (e.g., the write command and the associated address) to perform the write operation at a memory location corresponding to the address provided. In FIG. 3B, two command signals (e.g., a first command signal having a CMD A and a CMD B, and a second command signal having a CMD C and a CMD D) are shown, each being a two-cycle command that coincides with the timing of a corresponding CS.

As shown in FIG. 3B, after a controller I/O delay, a gated WCK, the CS, and the CA are provided to the controller I/O pins for transmission to the memory device through one or more links (or buses). For example, the WCK generated internally by the memory controller is provided to the controller I/O circuitry (e.g., the WCK gating circuitry 154 in FIG. 1B), which outputs the gated WCK to the WCK pin(s) of the memory controller. The CS and CA are provided to the CMD pin(s) of the memory controller.

Similar to the read operation described with reference to FIG. 3A, the memory controller does not transmit the CK to the memory device during the write operation. The memory device may generate its internal CK based on the gated WCK received from the memory controller according to a predetermined (or predefined) ratio (e.g., 1:2 or 1:4). Also, the memory controller transmits the gated WCK to the memory device based on a demand from command or data traffic between the memory controller and the memory device.

In FIG. 3B, two WCK toggling sessions are shown, where a first WCK toggling session 302_{W} starts at time T_{W}1 and ends at time T_{W}4, and a second WCK toggling session 304_{W} starts at time T_{W}7 and ends at time T_{W}10. During each of the first and second WCK toggling sessions, the gated WCK is active at the WCK pins of the memory controller.

Similar to the first WCK toggling session 302_{R} shown in FIG. 3A, the first WCK toggling session 302_{W} coincides with the timing of the transmission of the first command signal (e.g., CMD A and CMD B) at the CMD bus pins between time T_{W}1 and time T_{W}4. It is noted that, in the memory controller, the internal CS and internal CA (e.g., CMD A and COM B) are generated between time T_{W}0 and time T_{W}3. For the first WCK toggling session 302_{W}, the gated WCK is received at the WCK pins of the memory device between time T_{W}2 and time T_{W}5.

The second WCK toggling session 304_{W} starts at time T_{W}7, where the WCK starts toggling at the rising edge of the second command signal (e.g., having CMD C and CMD D) at the CMD bus pins of the memory controller. It is noted that, in the memory controller, the internal CS and internal CA (e.g., CMD C and COM D) are generated at time T_{W}6. In the present example, the write data associated with the write command starts transmission at time T_{W}8. It is noted that, at time T_{W}8, the gated WCK has already started toggling due to the demand from the transmission of the second command signal (e.g., CMD C and COM D) at time T_{W}7.

In some embodiments, preambles are needed for write operations. Hence, the WCK also needs to be toggled by a certain number of cycles toggling preambles earlier than the write data. In the embodiment shown in FIG. 3B, on the controller side, the second command signal (e.g., the CMD C and CMD D) is issued at time T_{W}7 before the write data transmission including 2 cycles of toggling preambles. Thus, at time T_{W}7, the gated WCK is toggled right away to accompany the CMD C and CMD D. As shown in FIG. 3B, while the transmission of the second command signal ends at the CMD bus pins at time T_{W}9, the WCK toggling does not stop until time T_{W}10. It is noted that, in the example shown in FIG. 3B, a postamble (tWPST) is employed, where the tWPST=2.5*tWCK toggling. Thus, two additional toggling WCK cycles are used even after the end of DQ traffic. As such, the second WCK toggling session 304_{W} ends at time T_{W}10.

In the embodiment shown in FIGS. 3A and 3B, the CK to WCK ratio can be determined based on the bandwidth requirement on the command bus. When a higher command bus bandwidth is required, a 1:2 ratio can be used so that twice the command bus bandwidth can be achieved as compared to the command bus bandwidth achieved based on a 1:4 ratio. When the 1:2 ratio is used, the memory device may use single-edge sampling for sampling the command signal(s). For example, the memory device may use the rising edges of the CK to sample the CMD A and the CMD B. When the 1:4 ratio is used, the memory device can use dual-edge sampling for sampling the command signal(s). For example, the memory device can use the rising edges of the CK to sample the CMD A, and use the falling edges of the CK to sample the CMD B.

It is noted that, in FIGS. 3A and 3B, two-cycle commands as opposed to single-cycle commands are used for the command signal (CA) transmission. While the two-cycle commands may involve more complex encoding as compared to single-cycle commands, the two-cycle commands can reduce the number of CA pins required for performing access operations as compared to single-cycle commands, thereby allowing for a higher number of I/O pins for data (or other signal) transmission or reception. It should be understood that, although two-cycle commands are shown in FIGS. 3A and 3B, more complex encoding schemes and commands having more than two cycles can be used to further reduce the number of CA pins.

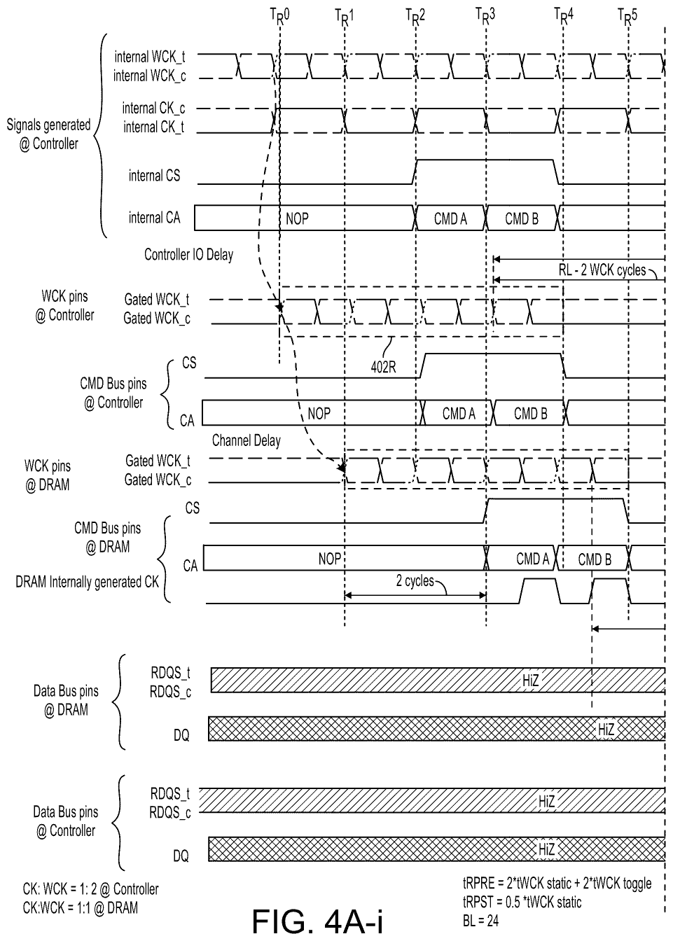

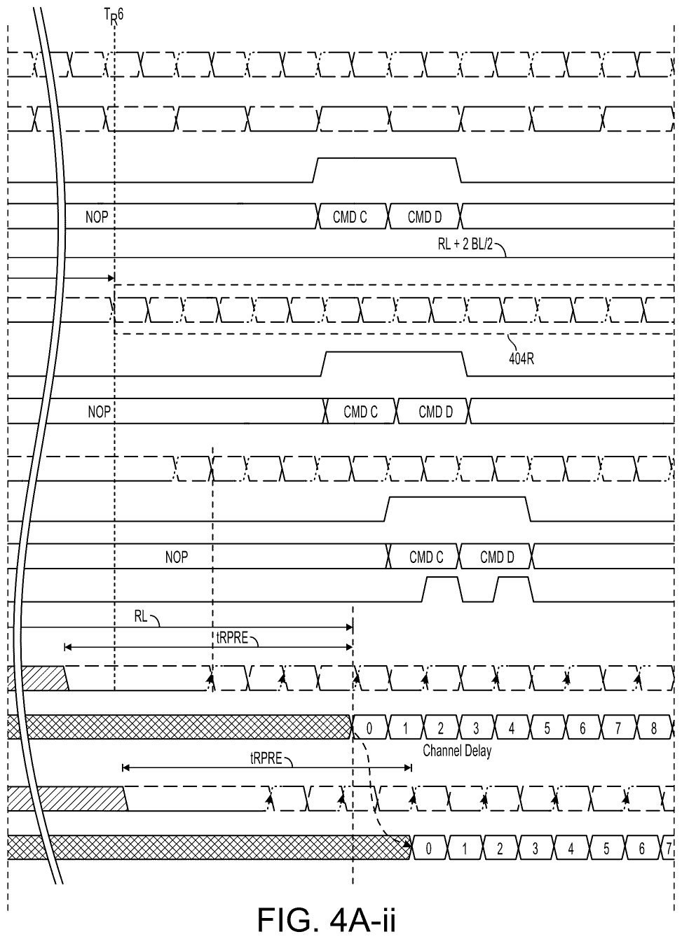

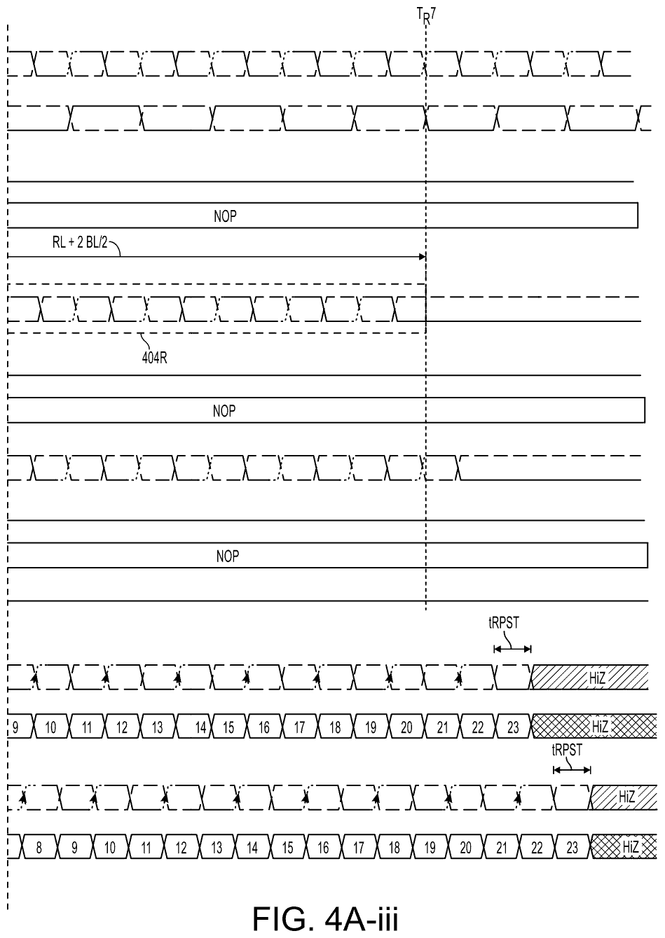

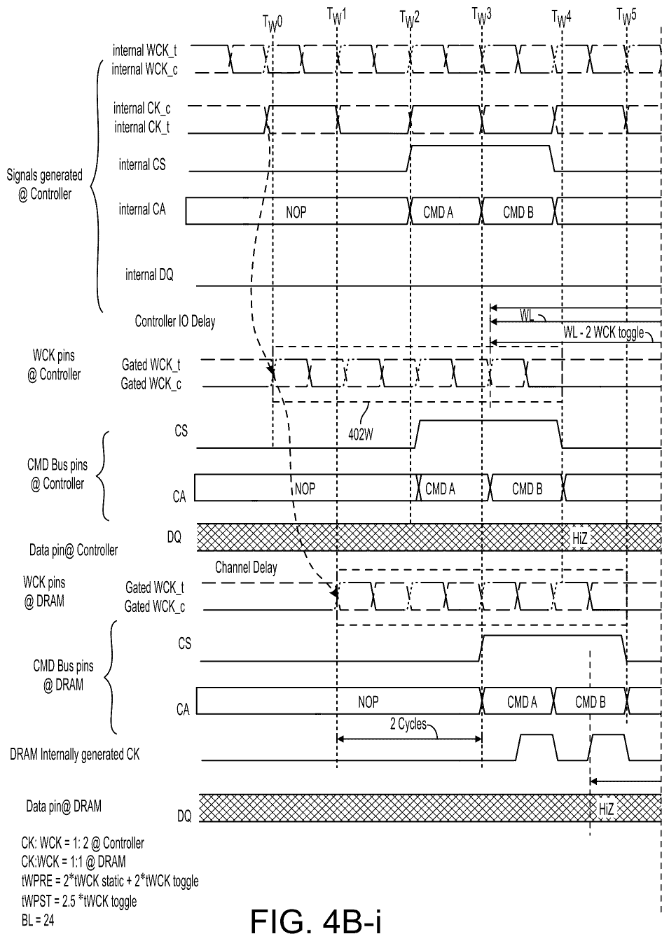

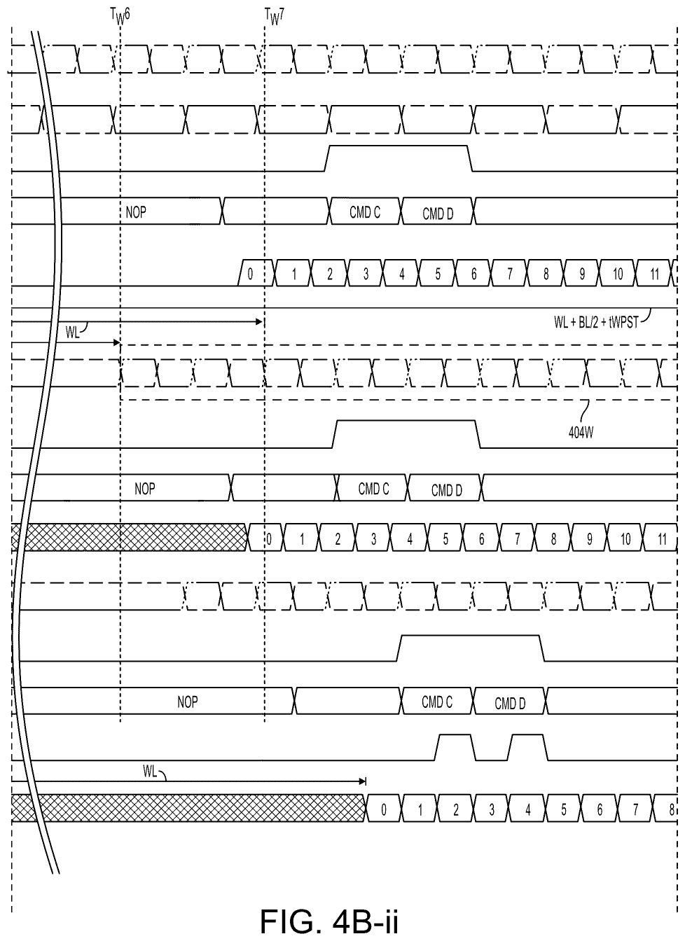

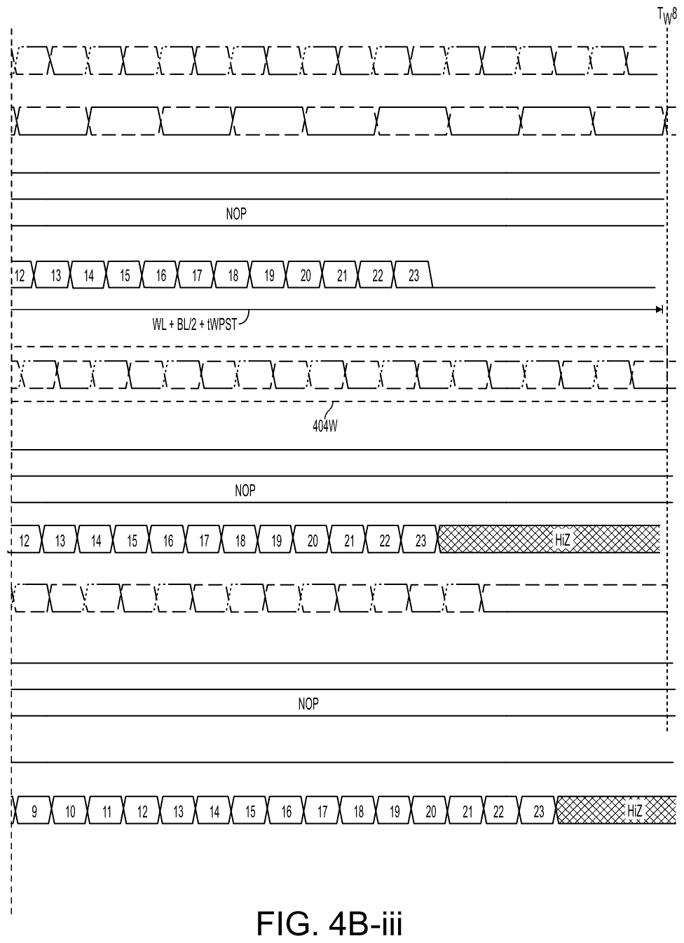

FIGS. 4A-i, 4A-ii, and 4A-iii (collectively referred to as FIG. 4A) illustrate a timing diagram of various signals during a read operation performed by a memory system, in accordance of an example embodiment of the present disclosure. FIGS. 4B-i, 4B-ii, and 4B-iii (collectively referred to as FIG. 4B) illustrate a timing diagram of various signals during a write operation performed by a memory system, in accordance of an example embodiment of the present disclosure. In one embodiment, the memory system may substantially correspond to the memory system 104 shown in FIGS. 1A and 1B. The memory system may include a memory controller and a memory device, which may substantially correspond to the memory controller 140 and the memory device 180, respectively, in FIG. 1B. In the examples shown in FIGS. 4A and 4B, two cycles of WCK toggling preambles are used before command (or data) bus activities.

The access operations shown in FIGS. 4A and 4B are substantially similar to those shown in FIGS. 3A and 3B. Different from FIGS. 3A and 3B, the CK internally generated by the memory device in the access operations shown in FIGS. 4A and 4B has a CK to WCK ratio of 1:1. In this case, the highest command bus bandwidth can be achieved because the duration spent on each command is minimized. Put differently, the WCK clocking rate is used directly to capture the associated commands.

In FIGS. 3A and 3B, because the CK frequency is divided down based on either a 1:2 or 1:4 ratio, the timing requirement among various signals is more relaxed (or forgiving) as compared to the case where the CK frequency is the same as the WCK frequency. Because the WCK frequency can be very high (e.g., 5 GHz or higher), preamble edges (e.g., pre-toggling) are preferred for the clocking on the command bus as well as on the data bus.

In FIG. 4A, two WCK toggling sessions are shown, where a first WCK toggling session 402_{R} starts at time T_{R}0 and ends at time T_{R}4, and a second WCK toggling session 404_{R} starts at time T_{R}6 and ends at time T_{R}7. During each of the first and second WCK toggling sessions, the gated WCK is active at the WCK pins of the memory controller.

For the first WCK toggling session 402_{R}, the gated WCK starts toggling in anticipation of a first command signal (e.g., the CMD A and CMD B). In the present example, when the CK is toggled at the same high frequency as the WCK, the system can be susceptible to ISI. Thus, to substantially eliminate ISI, as shown in FIG. 4A, in the memory device, the gated WCK starts toggling at time T_{R}1, two cycles before the CS and CA are received at the CMD bus pins of the memory device at time T_{R}3. The first two cycles of the gated WCK between time T_{R}1 and time T_{R}3 are used to condition the WCK and circuitry in the memory device so that a more robust CK can be generated at time T_{R}3. On the memory controller side, the gated WCK starts toggling at time T_{R}0 to ensure that, after the known channel delay, the gated WCK at the WCK pin(s) of the memory device can start toggling at time T_{R}1. It is noted that, for the first WCK toggling session 402_{R}, the gated WCK is received at the WCK pins of the memory device between time T_{R}1 and time T_{R}5.

The second WCK toggling session 404_{R} starts toggling in anticipation of the read data, similar to the second WCK toggling session 304_{R} in FIG. 3A. Hence, the details of the second WCK toggling session 404_{R} are omitted for brevity.

In FIG. 4B, two WCK toggling sessions are shown, where a first WCK toggling session 402_{W} starts at time T_{W}0 and ends at time T_{W}4, and a second WCK toggling session 404_{W} starts at time T_{W}6 and ends at time T_{W}8. During each of the first and second WCK toggling sessions, the gated WCK is active at the WCK pins of the memory controller.

Similar to the read operation shown in FIG. 4A, for the first WCK toggling session 402_{W}, the gated WCK starts toggling at the CMD bus pins of the memory device at time T_{W}1, two cycles before the CS and CA are received at the CMD bus pins at time T_{W}3. The first two cycles of the gated WCK between time T_{W}1 and T_{W}3 are used to condition the WCK and circuitry in the memory device so that a more robust CK can be generated at time T_{W}3. The second WCK toggling session 404_{W} starts toggling in anticipation of the write data. As shown in FIG. 4B, the gated WCK starts toggling at time T_{W}6, two cycles before the WL expires at time T_{W}7. The second WCK toggling session 404_{W} ends at time T_{W}8. It is noted that, in the example shown in FIG. 4B, a postamble (tWPST) is employed, where the tWPST=2.5*tWCK toggling. Thus, two additional toggling WCK cycles are used even after the end of DQ traffic. As such, the second WCK toggling session 304_{W} ends at time T_{W}8.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
a memory controller configured to generate a data clock signal; and
a memory device coupled to the memory controller, the memory device configured to:
receive the data clock signal from the memory controller; and
generate a system clock signal based on the data clock signal.

2. The system of claim 1, wherein the system clock signal is generated based on the data clock signal according to a ratio.

3. The system of claim 1, wherein the memory device is further configured to use the system clock signal to sample a command signal received from the memory controller.

4. The system of claim 1, wherein the memory device is further configured to generate a data strobe signal based on the data clock signal.

5. The system of claim 1, wherein the data clock signal is a gated data clock signal.

6. The system of claim 1, wherein the memory controller is configured to provide the data clock signal to the memory device based on a demand from command or data traffic between the memory controller and the memory device.

7. The system of claim 1, wherein the memory controller is configured to transmit one or more command signals based on the data clock signal, and wherein the memory controller does not transmit an internal system clock signal to the memory device.

8. A method performed by a memory system comprising a memory controller and a memory device, the method comprising:
providing, by the memory controller, a data clock signal to the memory device; and
generating, by the memory device, a system clock signal based on the data clock signal.

9. The method of claim 8, wherein the system clock signal is generated based on the data clock signal according to a ratio.

10. The method of claim 8, further comprising:
providing, by the memory controller, a command signal to the memory device, wherein the system clock signal is used by the memory device to sample the command signal received from the memory controller.

11. The method of claim 8, further comprising:
generating, by the memory device, a data strobe signal based on the data clock signal.

12. The method of claim 8, wherein the data clock signal is a gated data clock signal.

13. The method of claim 8, further comprising:
providing, by the memory controller, the data clock signal to the memory device based on a demand from command or data traffic between the memory controller and the memory device.

14. The method of claim 8, further comprising:
transmitting, by the memory controller, one or more command signals based on the data clock signal, wherein an internal system clock signal is not transmitted from the memory controller to the memory device.

15. A memory device, comprising:
data clock reception circuitry configured to receive a data clock signal; and
internal clock generation circuitry configured to generate a system clock signal based on the data clock signal.

16. The memory device of claim 15, wherein the system clock signal is generated based on the data clock signal according to a ratio.

17. The memory device of claim 15, wherein the system clock signal is used to sample a command signal received from a memory controller.

18. The memory device of claim 15, wherein the internal clock generation circuitry is further configured to generate a data strobe signal based on the data clock signal.

19. The memory device of claim 15, wherein the data clock signal is a gated data clock signal.

20. The memory device of claim 15, wherein the data clock signal is provided to the memory device based on a demand from command or data traffic between the memory device and a memory controller.
